(19) United States
(12) Patent Application Publication
(10) Pub. No.: US 2014/0014544 A1
(43) Pub. Date: Jan. 16, 2014

(54) CASSETTE FOR STORAGE OF MEDICAL INSTRUMENTS

(71) Applicants: Guillaume Bugnard, Basel (CH); Joachim Nafz, Waldachtal (DE); Klaus Kantorczyk, Waldachtal (DE)

(72) Inventors: Guillaume Bugnard, Basel (CH); Joachim Nafz, Waldachtal (DE); Klaus Kantorczyk, Waldachtal (DE)

(73) Assignee: Straumann Holding AG, Basel (CH)

(21) Appl. No.: 13/996,264

(22) PCT Filed: Dec. 20, 2011
(86) PCT No.: PCT/EP2011/006435

§ 371 Date: Oct. 3, 2013

(30) Foreign Application Priority Data
Dec. 23, 2010 (EP) 10 016 013.4

(51) Int. Cl. A61C 19/02

(52) U.S. Cl. CPC A61C 19/02
USPC 206/369

(57) ABSTRACT

Cassette (70) for a medical instrument (100) including at least one tray (1), the tray (1) having at least one holding means (10) for retaining the medical instrument (100). The holding means (10) has at least one magnetic element (20), in order to retain the medical instrument (100) and preferably a relief structure (13) which defines a seat (14) on which the instrument (100) can be securely retained by the magnetic element (20).

### FIELD OF THE INVENTION

The invention relates to a cassette for storage and sterilization of at least one medical instrument, in particular dental surgical equipment.

### BACKGROUND

Cassettes for storage of medical instruments represent well-known systems for storage, organization, presentation and sterilization of said instruments. Most of these cassettes comprise at least one tray in which the medical instruments are accommodated in holding means and a cover to close the tray.

Such a cassette is disclosed for instance in EP 08 016 174.8. The cassette described in this document includes a tray and a cover for storage, transport and sterilization of medical instruments. The tray comprises holding means containing cutouts, which are attached to the basic structure of the tray in a gap free manner. In this way, bacteria, fluids, dirt etc. cannot enter into any intervening spaces between these two components. Thus the medical instrument can be stored under clean and sterile conditions for a long time.

Further examples of cassettes for storage of medical instruments are described in U.S. Pat. No. 5,384,103, U.S. Pat. No. 5,979,643, WO 2005/053597, WO 2006/071180 and US 2007/0119737.

In the cassettes of the prior art the holding means are fixed on the tray by form fit, molding, welding or gluing order to have a connection which prevents the intrusion of the above mentioned substances. The cutouts, which hold the medical instruments in position, are designed to retain the medical instruments by a form-fit. These fittings have corners and edges and are therefore not easy to clean and sterilize for repeated use of the cassette. In addition, the cutout must accurately match the shape of the medical instrument it is designed to hold. Manufacturing tolerances are therefore small and even minor variations in size can result in an unfavourably tight or loose hold of the instrument. Over time repeated use of the holding means can result in a reduction in the cut out's ability to firmly hold the instrument. Further, in order to enable a particular cassette to be used with a wide range of instruments these instruments must be designed where possible with a standardized portion for retention within the holding means. Designing instruments in this manner allows new instruments to be held in a pre-existing cassette, however it places restrictions on the instrument design which are not related to its primary use.

### SUMMARY OF THE INVENTION

Therefore it is an aim of at least a preferred embodiment of the present invention to provide a cassette comprising holding means which are easy to clean and which provide a reliable, long lasting and secure means of retaining a medical instrument.

The cassette according to the present invention for storing at least one medical instrument comprises at least one tray, the tray comprising at least one holding means for retaining the medical instrument wherein the holding means comprises at least one magnetic element.

In the present invention therefore the medical instrument is retained within the cassette by means of magnetic force. The one or more magnetic element generates a magnetic field which passes through the tray surface, thus creating an area of retention on the tray surface to which a medical instrument having ferromagnetic properties can be fixed.

As discussed above, in the state of the art the medical instrument is fixed to the tray by a form-fit solution. In contrast, the use of a magnetic element allows more latitude in the design of the holding means and the tray respectively. Besides that, the medical instrument can also be designed exactly according to the needs of the surgeon. Further, the medical instrument can be quickly and securely attached to the tray. The tray is very easy to clean and sterilize because the use of magnetic elements allows targeted designs with less edges and corners, especially when according to a preferred embodiment the magnetic element is located within the tray. As a predetermined magnetic force is used to retain the medical instruments the manufacturing tolerances need not be so tightly controlled and the retentive force of the holding means remains constant over time.

The use of a magnetic element to provide tool retention rather than form fit cutouts allows the creation of a planar, unitary tray surface. The one or more magnetic element can be positioned flush with the tray surface but more preferably is located within the tray body. In this way joints or gaps on the tray surface can be avoided and the magnet can be hermetically sealed, thus preventing rust formation.

At its most simple, the entire tray surface can act as a single retentive area and any number of medical instruments attached to this. However, this can result in a somewhat chaotic and unordered storage, making it difficult for the user to select the desired tool.

One solution for overcoming this drawback is to provide a plurality of magnetic elements, thus creating a plurality of separate retention areas on the tray surface. In this way each medical instrument can be held on a separate retention area, making selection and removal of each instrument easier. This also avoids any damage or contamination to the instruments which may occur if these contact one another.

In order to assist with identification of the tools and location of the individual magnetic elements the tray may comprise markings on the tray surface which act as visual indicators to the user of the position of the retentive area(s). Such markings can, for example, take the form of the outline of the tool to be placed in a particular retention area. These provide a visual guide to the user as to which tool should be positioned where.

In a preferred embodiment however, the holding means further comprises at least one relief structure which defines a seat for the at least one medical instrument. By “relief structure” it is meant a structure having a non-planar profile. The structure therefore rises out of the tray surface and/or forms a depression. The relief structure thus creates a non-planar area of tray surface. By “seat” it is meant an area shaped to receive at least part of a medical instrument and on which the instrument can be securely retained by the magnetic element. Thus, in such embodiments the magnetic element and seat are positioned relative to each other such that the instrument can be securely retained on the seat by magnetic force. In this preferred embodiment the seat must be defined by the relief structure rather than simply a visual indicator, i.e. the seat is physically distinct, or separated, from its surroundings.

Thus, according to one preferred embodiment the cassette comprises at least one medical instrument, at least a part of which is held on a seat defined by a relief structure, the medical instrument being held on the seat by magnetic force.

As well as enabling a plurality of instruments to be held in isolation from each other, the use of relief structures has additional benefits, depending on the shape these structures take.

Although it could at first be thought that providing a planar tray surface would be most beneficial in terms of sterilization, this is in fact not always the case. When a medical instrument lies on the tray surface, those areas in direct contact with the tray cannot be effectively sterilized. Therefore, in cases in which the instruments are to be sterilised while held within the cassette, it is beneficial to have as little direct contact between the instrument(s) and tray as possible.

Preferably therefore, the relief structure is arranged such that, in use, it does not directly contact the medical instrument along its entire length and/or its entire width.

In order to achieve this, in one embodiment the relief structure comprises a raised surface on which a part of the medical instrument can be held. The raised surface therefore forms a seat for a part of the medical instrument located above the surface of the tray. As only a part of the instrument is positioned on the raised surface the remaining portions of the instrument extend beyond this and are fully exposed to sterilization fluid. This enables a more complete sterilization of the instrument.

The raised surface can be formed by providing a relief structure comprising one or more protrusions. In preferred embodiments the at least one magnetic element can be housed within this protrusion.

Thus, in a preferred embodiment the cassette comprises at least one medical instrument, a part of the medical instrument being seated on a surface of a raised protrusion, said protrusion housing a magnet.

Typically the seat is formed by the distal surface of the protrusion, such that the protrusion acts as a platform for the instrument. However, in some instances the seat may be formed by the side wall or walls of the protrusion(s). That is, the protrusion is designed such that the top surface or side surface is shaped to seat the medical instrument. In the latter case a single magnetic element housed within a protrusion may form two isolated retention areas, one on each side of the protrusion. Therefore a single relief structure can hold two instruments. It is further possible for a single protrusion to hold three or more instruments, by forming seats on the side and distal surfaces of the protrusion.

A large protrusion can of course have more than one seat on each surface, particularly on its distal surface.

Alternatively, the relief structure may comprise two protrusions and two related magnetic elements, such that each end of an elongate instrument can be held by the holding means, leaving the central portion exposed for sterilization and gripping by the user.

In a preferred embodiment each relief structure defines a seat for no more than one medical instrument. Thus, in use, each medical instrument is seated on a seat defined by an individual relief structure or structures. Therefore, in this embodiment, while multiple relief structures can act in combination to define a seat for a medical instrument, multiple instruments are not seated on seats defined by the same relief structure. For example, two or more protrusions can define a single seat for a medical instrument; however two instruments cannot be seated on the same protrusion or group of protrusions. This ensures that the instruments are well spaced and prevents contamination from one instrument to another. It can also assist with ease of use of the cassette as each instrument is clearly distinguished from the other instruments in the cassette.

Improved sterilization can further be achieved, in addition to or separately from the above feature, by providing a relief structure comprising a textured surface such that, in use, channels are formed between the medical instrument and the seat. In this way, the seat does not contact the medical instrument along its entire length/width and sterilizing fluid can flow between the instrument and seat, thus increasing the effectiveness of the cleaning procedure. The textured surface can be, for instance, a series of grooves and/or ridges, raised dimples, waves etc. The important requirement is that a flow path is provided which extends along the length or width of the seat.

Thus, in a preferred embodiment, the cassette comprises at least one medical instrument, at least a part of the instrument being held on a seat, said seat comprising a textured surface such that the seat does not contact the part of the medical instrument held on the seat along its entire length and/or entire width.

In some embodiments the relief structure can take the form of such a textured surface only. In other embodiments the textured surface may be provided in addition to other relief features, for example the above discussed protrusion(s).

In a preferred embodiment the textured surface takes the form of at least one longitudinal groove extending along the length of the seat. This provides at least one sterilisation channel extending along the length of the seat. Preferably the textured surface consists of a single longitudinal groove extending along the length of the seat. This maximises the width of the sterilization channel. Preferably, in use, the longitudinal direction of the seat corresponds to that of the longitudinal axis of the instrument held by the seat, such that at least one sterilisation groove extends along the length of the instrument held on the seat.

Although the magnetic force provided by the holding means of the present invention provides a strong, reliable vertical retention to the medical instrument it offers less protection against lateral displacement, for example through accidental knocking or bumping of the tray or individual instruments.

Therefore it is preferable for the relief structure to comprise at least one lateral retention element which at least partially borders the seat. In contrast to the two previously discussed relief structures, the seat defined by the lateral retention element(s) is not positioned on the relief structure itself but by the area beside, between or within this. In order to provide lateral retention the element must extend above the seat surface such that it provides an abutment surface for the seated instrument. Thus the lateral retention elements prevent or inhibit movement of the instrument in a direction parallel to the tray surface. This is referred to throughout the specification as “lateral movement” to distinguish this from vertical movement, i.e. away from the tray surface.

The lateral retention element improves the resistance of the seated instrument to displacement in the event that this is knocked during transport or use of the cassette. The at least one lateral retention element can take the form of a plurality of walls, or flanges, which define isolated regions of the tray surface. Each region acts as a seat and thus a plurality of medical instruments can be stored separately from one another.

The at least one lateral retention element may alternatively comprise a recess in the tray surface shaped such that a medical instrument or part of a medical instrument can be accommodated within this. When the lateral retention element is formed by a recess the base of this recess defines, at least in part, the seat of the relief structure.

Although a seat can be provided which has greater dimensions than the instrument to be retained, the seat is preferably defined such that in at least one dimension, e.g. width, the seat is substantially equal to the instrument dimension. Preferably, the lateral retention element(s) border or partially border this dimension of the seat such that, in use the lateral retention element closely borders the seated medical instrument. In this way, the lateral retention means can provide a secure lateral retention and a clear physical feedback to the user that the instrument is correctly positioned on the seat. The lateral retention element at least partially borders the seat such that the medical instrument will “fall” or “snap” into this seat once correctly aligned with the lateral retention element(s). This element can therefore also provide a visual and physical indication to the user of the location of the seat.

Thus, in a preferred embodiment, the cassette comprises at least one medical instrument, at least a part of the instrument being held on a seat by magnetic force, said seat having at least one dimension substantially equal to a dimension of the part of the instrument held on the seat, wherein lateral retention elements at least partially border this dimension of the seat so as to closely border the seated medical instrument.

Preferably the lateral retention element comprises one or more flanges. Preferably two opposing flanges are provided. In embodiments in which the holding means comprises a raised surface the lateral retention element may comprise one or more flanges extending substantially perpendicular to the seat surface and can border all or part of the seat. In other embodiments the lateral retention elements may taper inwards towards the seat surface in order to guide the instrument.

The recesses or flanges can be patterned with the above discussed surface texture to allow flow of sterilizing fluid around the instrument.

The lateral retention element can be shaped so as to provide a form fit connection between the holding means and the instrument, and thus also provide some vertical retention to the instrument. However, in preferred embodiments the strength of the magnetic element is great enough that no additional vertical retentive force is necessary. Therefore preferably the at least one lateral retention element is arranged to provide lateral retention only, even in situations where the element is in contact with the seated instrument. In this way, the lateral retention element maintains the instrument in its location should this be accidentally knocked or bumped but does not secure the instrument against vertical displacement. This retention is instead provided exclusively by the magnetic element(s).

The relief structure of the holding means can comprise one or a combination of any of the above features, i.e. raised surface, surface texture and/or lateral retention element(s). For example, the seat may be defined by opposing lateral retention elements extending from the tray surface, the tray surface between the retention elements having texturing to create sterilization channels. Alternatively the seat may be defined by a protrusion, the protrusion housing a magnet and having a textured surface which forms one or more sterilization channels. However in a particularly preferred embodiment the relief structure comprises all of the above features in combination. Therefore the holding means preferably comprises a raised surface defining a seat on which at least a part of a medical instrument can be held, said seat being at least partially bordered by at least one lateral retention element, preferably in the form of opposing flanges, and comprising surface texturing such that, in use, channels are formed between the medical instrument and the seat. Preferably the surface texture is in the form of at least one groove extending along the longitudinal length of the seat.

The preferred magnetic strength of the magnetic element will depend on the tool to be retained, the number of magnetic elements used, the distance between the element and seated instrument etc. Preferably the magnetic strength is selected such that, in use, the medical instrument is retained with a force of between 1-10N.

The magnetic element can be any permanent magnet capable of generating a magnetic field. It can be formed from any magnetized ferromagnetic or ferrimagnetic metal such as iron, nickel, cobalt or their oxides, e.g. ferrite or magnetite. A suitable magnetic element can also be formed of an alloy such as iron, aluminum and nickel with cobalt, manganese or copper additives.

It is possible for the magnetic element to be positioned on, or inset into either the upper surface or base of the tray. However, leaving the magnetic element in an exposed position results, over time, in rust formation. This in turn reduces its magnetic properties and increases the risk of non-biocompatibility contamination. Therefore, in a particularly preferred embodiment, the magnetic element is hermetically sealed, thus preventing rust formation. This can be achieved by supplying the magnetic elements with a plastic casing or biocompatible metal shell such as titanium or a stainless steel alloy. These can then be glued or otherwise fixed in recesses on the tray surface or base. Preferably however the at least one magnetic element is sealed within the tray. In one embodiment the upper surface or base of the tray may comprise recesses into which the magnetic elements are placed and then covered with a plastic coating to seal these within the tray.

Alternatively sealing can be achieved through injection moulding, wherein the at least one magnetic element is placed within the mould prior to the formation of the tray. Alternatively, the tray may comprise recesses on the tray base or upper surface into which the magnets can be placed and then hermetically sealed by means of a plastic or metal lid that is glued or welded into place. Preferably the magnetic elements are sealed within the tray via the base. In this way any discontinuities, ridges or grooves etc caused by the sealing procedure will be located on the base of the tray rather than the upper surface. This is beneficial at it reduces the potential dust and bacteria “traps” on the tray surface, which is the surface most likely to be contaminated during use.

In the above described examples it is not possible to remove the magnetic elements once these have been sealed within the tray. However, in other embodiments the at least one magnetic element can be removably contained in the tray. This may be desirable when the tray is supplied for use with different sets of instruments, so that the magnets can be repositioned within the tray or replaced by magnetic elements of different magnetic strength. In such embodiments the magnetic elements can be placed in an openable chamber within the tray.

The location of the magnetic element(s) will depend on tray design and the medical instrument(s) in question. In most instances it is preferable to locate the magnet directly beneath or adjacent to the seat defined by the relief structure.

The thickness of the tray between the magnetic element and seat can vary and will be determined by the magnetic strength of the element and the desired retention force. However, generally it is preferred that the magnetic element be positioned no greater than 2 mm from the seat. This is because magnetic force is inversely proportional to the square of the distance (1/d²). Therefore, positioning the magnetic element further from the seat results in a large increase in the magnetic strength necessary to provide the required retention force.

The tray of the present invention comprises an upper surface, on which in use the medical instrument is held, and a base surface opposite the upper surface. The tray is formed of a rigid material such as plastic or metal. When a metal tray is used the entire surface of this tray can be magnetized. Preferably however the tray is formed of a hard plastic material such as polypropylene, high density polypropylene, polysulfone (PSU), polyphenylsulfone (PPSU), polycarbonate (PC), polyetheretherketon (PEEK), PMMA or PTFE. The tray may be modular, i.e. the tray can be constructed from several pieces which are then welded, bonded or otherwise joined to form a gapless upper surface. This enables individualized trays to be created which have, for example, a particular layout of holding means or which are constructed from different materials. However, preferably the tray is integrally formed, e.g. by injection moulding. This simplifies manufacture and prevents any risk of creating contamination traps. Preferably the relief structure forms an integral part of the tray, although it is also possible, particularly when the relief structure comprises protrusions, for these to be created as separate components which are then fixedly secured to the tray. Integral protrusions are however preferred as this creates a gap free upper surface and thus reduces the risk of contamination. The corners and edges of the relief structure may be rounded off similar to a coving, in order to prevent bacteria, fluids, dirt etc. from adhering to these areas.

As discussed above, the cassette preferably comprises at least one medical instrument retained by the holding means. The at least one medical instrument is preferably a dental surgical instrument and may be for example a drill, tap, depth gauge, sleeve, implant adapter or ratchet. Preferably the tray comprises a plurality of holding means such that the cassette can store a plurality of medical instruments. In a preferred embodiment the plurality of holding means comprise a plurality of protrusions, each housing at least one magnetic element. In another or the same preferred embodiment the plurality of holding means each comprise opposing lateral retention means at least partially bordering one dimension of the seat. In another or the same preferred embodiment the plurality of holding means each comprise a textured surface for creating sterilistaion channels between the seated instrument and the seat.

The cassette may further comprise a lid. This can be attached to the tray by means of hinges, clamps etc. Either the lid or the tray, or both, may comprise four side walls defining the interior volume of the cassette. The one or more medical instrument is held within this interior volume by the holding means. In an alternative embodiment, the cassette comprises a separate base component comprising a bottom surface and four side walls defining an interior space. The tray can be arranged to fit over the top of the base (effectively sealing the base) or inside the base at a determined distance from the bottom surface. Generally the tray is orientated parallel to the bottom surface. The tray is preferably fixed to the base in a detachable manner. The base may house a plurality of trays and may itself consist of a tray according to the present invention. In addition the cassette may comprise an intermediate portion located between the base and the lid onto which can be arranged a further tray.

In the state of the art, the holding means comprise a mechanical- or form-fitting system, where it is difficult to remove the medical instruments with a predetermined force. This can be done, in a convenient way, when the medical instrument is held by a magnetic force. Further, the shape of the magnetic element can be adjusted to almost any design need; therefore it can have a cuboid-like, a cube-like or a U-like shape as long as it keeps up its basic function.

Viewed from another aspect the present invention provides a cassette of the type described above further comprising at least one medical instrument retained within said holding means.

Viewed from a further aspect the present invention provides a kit comprising a plurality of medical instruments and a cassette for storing said instruments, the cassette comprising at least one tray, said tray comprising a plurality of holding means for retaining said medical instruments, each holding means comprising at least one magnetic element and relief structure, said relief structure defining a seat for at least one instrument on which the instrument can be retained by magnetic force.

The preferred features of the invention, except where obviously mutually exclusive, can be used in combination with any number of the other preferred features.

### BRIEF DESCRIPTION OF THE DRAWINGS

Particularly preferred embodiments of the present invention are described below, by way of example only, and illustrated in the drawings in which purely schematically:

FIG. 1 shows schematic perspective view of a tray comprising a variety of holding means in accordance with the present invention;

FIGS. 1a-g show cross sections through each of the holding means shown in FIG. 1;

FIG. 2a shows a lateral cross-sectional view of a holding means according to the present invention;

FIG. 2b shows a lateral cross-sectional view of an alternative holding means according to the present invention;

FIG. 2c shows a lateral cross-sectional view of an alternative holding means according to the present invention;

FIG. 2d shows a lateral cross-sectional view of an alternative holding means according to the present invention in which magnetic elements are arranged in the side walls of the holding means;

FIG. 3 shows a lateral cross-sectional view of a holding means according to the present invention;

FIG. 4 shows, in a perspective view, a tray comprising holding means with integrated magnetic elements;

FIG. 5 shows the tray of FIG. 4 forming the base of a cassette in accordance with the present invention, and

FIG. 6 shows, in a bottom perspective view, the cassette of FIG. 5.

### DETAILED DESCRIPTION

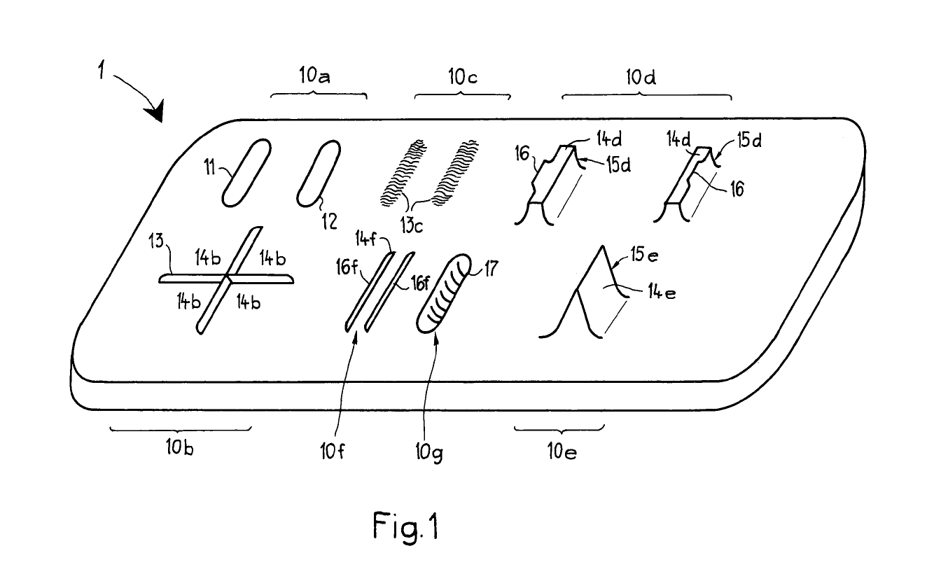

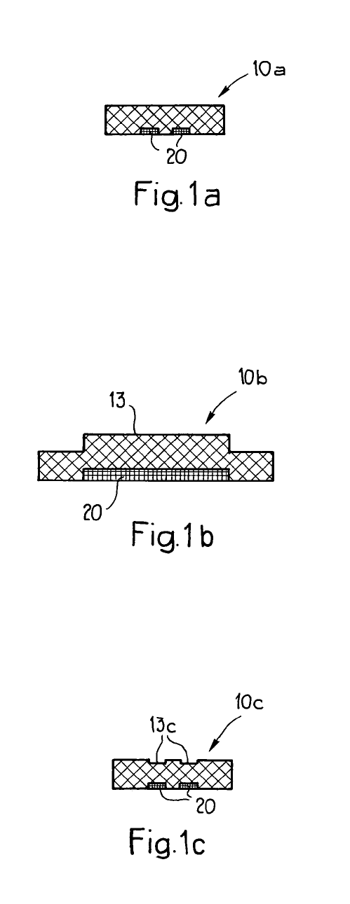

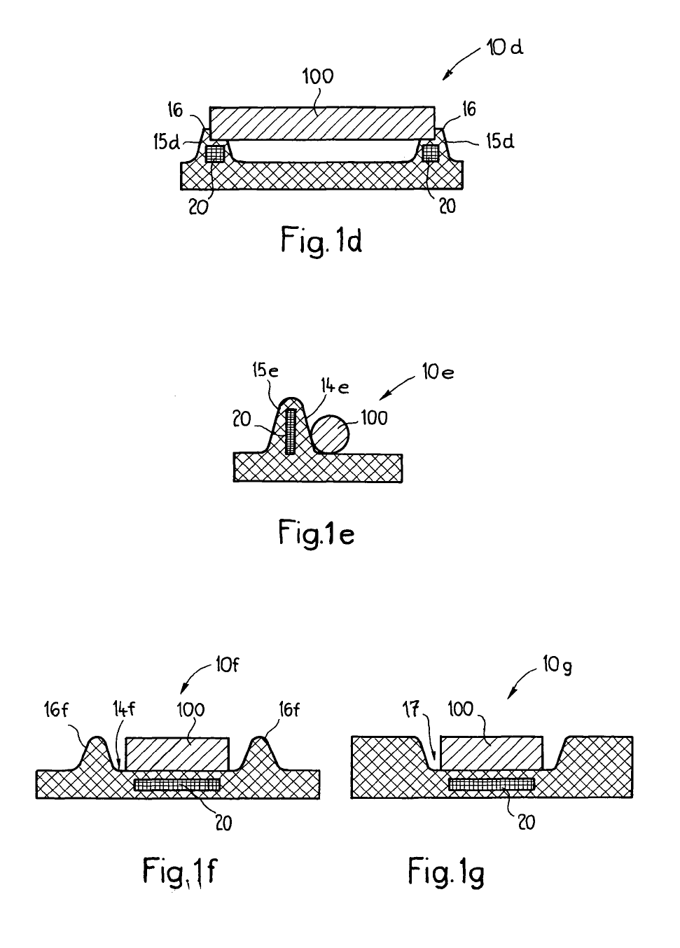

FIG. 1 shows a tray 1 in accordance with the present invention on which a number of different types of holding means 10 are demonstrated.

The simplest form of holding means 10a consists of two magnets 20 located within the tray body, see FIG. 1a. The tray surface above the magnets is planar. However, in order to indicate the location of the magnets the planar tray surface is marked by rings 11, 12. The user therefore knows where to place the medical instruments in order to securely attach these to the tray 1. The rings 11, 12 could be replaced by outlines of particular medical instruments or could be coloured. Holding means 10a could be used to hold a single medical instrument positioned across both magnets but also enables two instruments to be held separately, one on each magnet.

Isolated retention areas for different instruments can also be provided through the use of a holding means having a relief structure. One such holding means 10b comprises a single magnet 20 positioned below the tray surface and a relief structure 13 in the form of a cross shaped wall protruding from the tray surface. This relief structure defines four separate seats 14b, on which can be placed four different instruments. Relief structure 13 prevents the instruments from coming into contact with one another and provides some lateral retention in addition to the vertical retention provided by the magnet 20.

In the holding means 10a, 10b so far described, the instrument contacts the planar surface of the tray 1 when held by the holding means 10a, 10b. This is disadvantageous in terms of sterilization as a large contact area exists between the tray 1 and instrument.

Holding means 10c comprises two magnets 20, again positioned within the tray. In the area above each magnet relief structure 13c is formed. This structure 13c takes the form of small, wavelike grooves which create a textured surface. Each relief structure 13c defines a seat for a medical instrument and allows a flow of sterilizing fluid to pass under the instrument when this is held on the holding means 10c, thus improving the sterilization process. In this embodiment the wavelike grooves form channels across the width of the seat. The instrument to be placed on relief structures 13c should have a width less than the length of the grooves such that sterilizing fluid can flow past the underside of the instrument.

Another way of reducing the contact between the instrument and tray surface is to provide a relief structure in the form of protrusions. Holding means 10d comprises two protrusions 15d. Each protrusion 15d contains a magnet 20 and provides a raised top surface that defines an instrument seat 14d. Each protrusion 15d could be used to seat a separate instrument, however in this example it is intended that an instrument 100 be positioned with one end on each protrusion 15d, as shown in FIG. 1d. In either configuration, the protrusions 15d are sized such that a portion of the instrument projects out over the protrusion 15d and hence is fully exposed to sterilizing fluid. In addition the exposed part of the instrument can be easily gripped by the user when removing or replacing the tool.

In order to correctly locate the instrument on the seat 14d defined by holding means 10d, lateral retention elements in the form of flanges 16 are provided. These partly border seat 14d and provide lateral retention to an instrument held on the seat 14d. These also provide the user with physical feedback once the instrument has been correctly positioned. In the present embodiment a single flange 16 is arranged on each protrusion 15d such that an instrument 100 positioned across the two protrusions 15d will be bordered in the longitudinal dimension of the instrument. In cases in which each protrusion 15d is designed to hold a separate instrument, a second flange can be provided on each protrusion 15d opposite the first flange. In this way the flanges 16 can provide a secure lateral retention in the width dimension of the instrument. Although not shown in this embodiment, seats 14d can comprise grooves or other surface texturing similar to that of holding means 10c.

Instead of defining an instrument seat on the top surface, protrusions can also be designed to seat an instrument on their side surfaces. Such a protrusion 15e is shown in holding means 10e. One or both side surface of this protrusion 15e can define a seat 14e for a medical instrument 100, with the magnet 20 being situated within the protrusion 15e. As with holding means 10d, the protrusion 15e is dimensioned such that the instrument will project beyond the protrusion for ease of sterilizing. In addition, depending on the strength of the magnet 20 the instrument can be held above the tray surface. Surface texturing, such as that shown in holding means 10c, or flanges such as those shown in holding means 10d, can also be applied to holding means 10e.

As discussed in relation to holding means 10d, lateral retention elements can be provided to better retain the instrument on the holding means. Holding means 10f, 10g contain further examples of such lateral retention elements. Holding means 10f comprises two opposing flanges 16f, between which is defined instrument seat 14f. A magnet 20 is positioned below seat 14f in order to provide vertical retention to an instrument 100 placed on seat 14f whereas flanges 16f prevent lateral movement of the instrument. The distance between flanges 16f is similar to the width of medical instrument 100, such that the holding means 10f also provides the user with physical feedback when the instrument 100 is correctly seated. When the instrument 100 is correctly aligned with the flanges 16f it will fall or snap into position on the seat 14f.

Holding means 10g comprises a recess 17 on the tray surface. This recess is shaped to house a medical instrument 100. A magnet 20 is located below the tray surface to provide vertical retention while the side walls of recess 17 prevent lateral movement of the tool. The base of recess 17 defines a seat for the instrument.

The various holding means 10 of FIG. 1 demonstrate the variety and range of holding means available. As briefly discussed, the various types of holding means can be used independently or in combination. The essential requirement of each holding means of FIG. 1 is the provision of a magnet to provide vertical retention to the medical instruments.

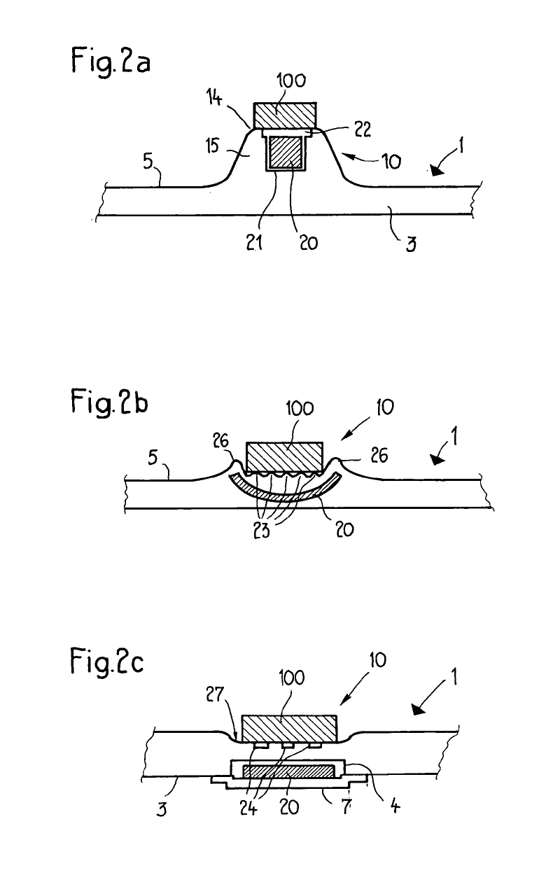

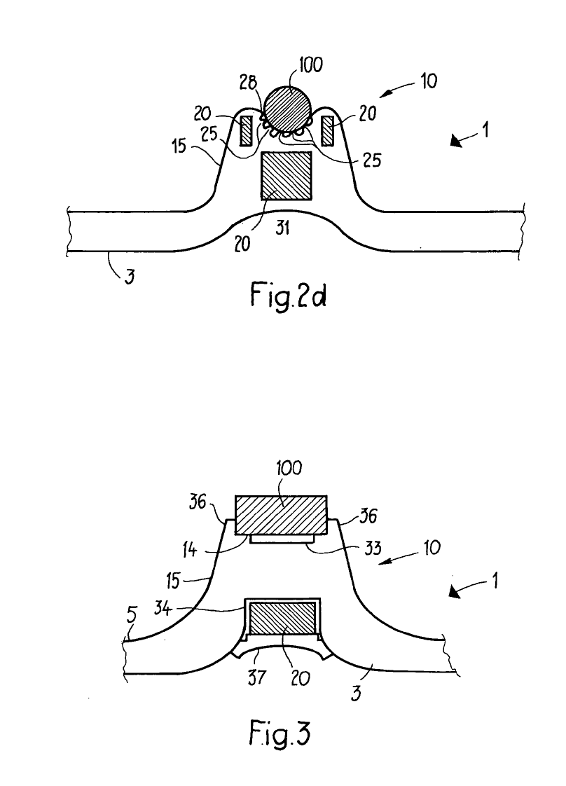

FIGS. 2A-D show cross sections through various holding means according to the present invention in order to demonstrate different locations, shapes and fixation methods for the magnetic elements.

FIG. 2a shows a cross section of a tray 1 with a rigid basic structure 5 comprising a holding means 10 formed by protrusion 15 and a magnetic element 20. In this embodiment the protrusion 15 defines a seat 14 for a medical instrument 100 on its top (distal) surface, where a medical instrument 100 or the shaft of a medical instrument 100, such as a drill, screwdriver and/or wrench, can be retained by a magnetic force. Surface texture in the form of groove 22 is provided in the seat 14 in order to create a channel between the seat 14 and medical instrument 100. This allows sterilizing fluid to flow under the medical instrument for a more thorough sterilisation. The medical instrument 100 is preferably exclusively held by a magnetic force, with no additional mechanisms or means. The magnetic force is provided by permanent magnet 20, which is housed within protrusion 15.

In this embodiment magnet 20 is encased in a metal shell 21 and glued or otherwise fixed into a recess in the protrusion 15. In this embodiment therefore, the magnetic element 20 is hermetically and fixedly sealed into the upper surface of the tray 1. This creates the smallest distance between the magnetic element 20 and the seat 14. It is also possible however for the magnetic element 20 to be glued or welded into a recess in the base of the tray, as will be shown below.

FIG. 2b shows a cross section of a holding means 10 similar to holding means 10f. Two opposing flanges 26 define a seat for instrument 100 wherein the seat and instrument 100 have a similar dimension. The seat comprises a surface texture in the form of ridges 23 which form channels between the seat and the instrument 100. The curved, wave-like design of the holding means 10 further facilitates the cleaning and sterilizing of the tray 1.

Here, magnetic element 20 has a U shape and is integrally formed in the tray. This can be achieved through injection moulding.

FIG. 2c shows a cross section of a holding means 10 similar to holding means 10g. Recess 27 defines a seat at its base for retaining a medical instrument 100. The side walls of recess 27 act as lateral retention means and protect the instrument 100 from being knocked or bumped out of the seat. These side walls taper inwards towards the instrument seat to assist in guiding the instrument during placement. The base of recess 27 comprises a series of grooves 24 which form channels for sterilization fluid.

Base 3 of tray also comprises a recess 4 in which magnet 20 is housed. The recess is closed by cover 7. In some embodiments this may be removeably attached to the tray 1, for example by screws. However in preferred embodiments the cover 7 is permanently sealed to the tray, e.g. by sonic or laser welding.

In some cases it can be desired to associate more than one magnetic element with each seat. FIG. 2d shows a cross section of a holding means 10 comprising a protrusion 15 within which three magnets 20 are integrally moulded. Protrusion 15 comprises a recess 28 on its upper surface, such that the seat is defined by the base of this raised recess 28. The walls of recess 28 form lateral retention elements and surface texture in the form of raised dimples 25 allow fluid to flow between the instrument 100 and the seat. One magnet 20 is located directly beneath the base of recess 28 whereas the other two are located in the lateral retention elements. Base 3 of the tray 1 is not planar but comprises a hollow 31 underneath protrusion 15. This reduces the amount of material used and reduces the weight of the tray.

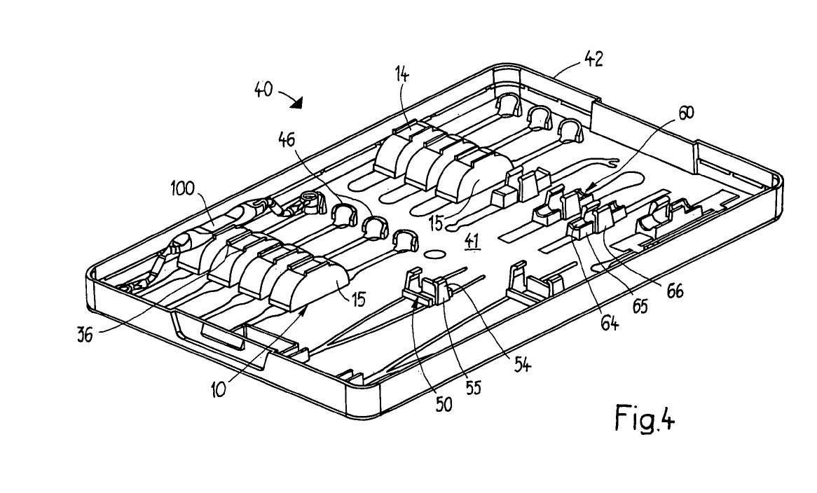

A particularly preferred holding means 10 is shown in lateral cross section by FIG. 3. Once again tray 1 is formed of a rigid basic structure 5 and comprises a holding means 10 in the form of a protrusion 15. This protrusion 15 takes the form of a rectangle with rounded corners (as can be seen in FIG. 4). Top surface of protrusion 15 forms a seat 14 for medical instrument 100. Single groove 33 runs along the longitudinal length of the seat 14, thus creating a channel for sterilization fluid. In the mid-section of protrusion 15, though which the cross section is taken, flanges 36 border the seat 14 and contact the seated medical instrument 100. These do not however provide any vertical retention to the instrument 100. This is instead provided solely by magnet 20, which is housed within the protrusion 15. This is hermetically sealed within a recess 34 on the base 3 of tray by cover 37.

Preferably the relief structures shown in all the above embodiments are formed in one piece with the tray 1 as this avoids joints in the tray 1. All of the relief structures shown in these embodiments can be combined with relief structures shown in other embodiments. In addition each of the magnet configurations disclosed, e.g. located on the tray surface, within the tray, within open or closed recesses, can be used in any of the above embodiments. Each of the holding means disclosed can comprise one or a plurality of magnets.

The holding means 10 have edges and corners which may be rounded off similar to a coving, in order to facilitate the cleaning and sterilizing of the tray 1.

In order to utilize the magnetic force of the magnetic element 20, the medical instrument 100 must be made of a ferromagnetic material.

FIG. 4 shows a perspective view of a tray 40 comprising the holding means 10 of FIG. 3. Tray 40 comprises a base 41 and four side walls 42, defining an interior volume. Holding means 10 are positioned on the upper surface of base 41 such that the instruments 100 are held within the interior volume of the tray 40. In this perspective view the rounded rectangular shape of protrusions 15 is clearly visible. The rounded upper surface of the protrusions 15 is beneficial for sterilization of the tray 1. The top of protrusion 15 is flattened to create a seat 14 for a medical instrument 100. Flanges 36 border the seat 14 and provide lateral retention to the seated instrument 100. Although not shown in this figure the seat 14 also comprises a groove in the longitudinal direction to allow flow of sterilizing fluid under the seated instrument 100. Magnets are provided in each protrusion 15 to magnetically retain the instruments 100. As is clearly seen in this figure, only a part of the instrument 100 is fixed to the holding means, leaving many other parts fully exposed for sterilization. Additional flanges 46 are provided to define and indicate the correct positioning of the tool on the holding means 10. These can also be associated with a magnetic element for extra vertical retention of the instrument 100. Tray 40 further comprises additional holding means 50, 60 designed to hold different medical instruments (not shown). Outlines of the tools intended to be held by each holding means are marked on the tray surface. Holding means 50 comprises a protrusion 55 which defines a seat 54 on its side wall. The inside surface of the arms of the medical instrument can be magnetically held on this seat 54 by the holding means 50. Holding means 60 comprises a protrusion 65 having on its top surface a curved recess forming a seat 64. Flanges 66 provide lateral retention and in this case are also shaped to provide additional vertical retention via a form fit with the medical instrument. As can be seen from this figure, each retention structure in this embodiment is used with a single medical instrument; no single structure is used to seat two separate instruments.

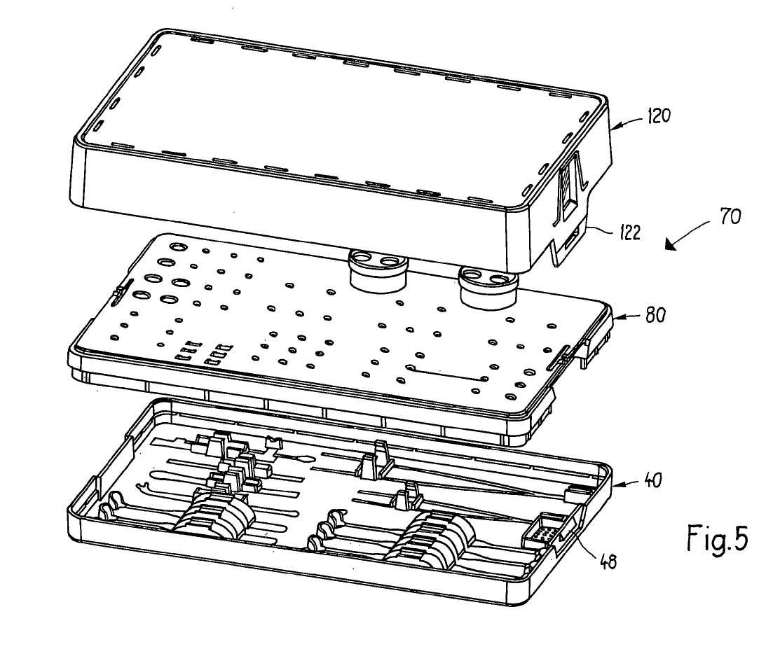

FIG. 5 shows a cassette 70 for the storage of medical instruments. The tray 40 of FIG. 4 forms the base of the cassette 70. Intermediate section 80 is shaped to fit over tray 40 and thus provide an additional surface for instrument storage. This section 80 may itself comprise magnetic holding means according to the present invention. Alternatively or in addition this can also comprise traditional holding means. The cassette 70 can be closed with cover 120 for the transport or the storage of the medical instruments. The cover 120 may be fixed to the base tray 40 by means of tabs 122 designed to connect to fastening means 48 on the exterior of tray 40. The base tray 40, intermediate section 80 and cover 120 are made of a metal or a rigid plastic material which can resist standard sterilization procedures and impacts from the outside. The base tray 40 or the cover 120 can be provided with anti-slip means in order to avoid slipping of the cassette 70 if it is placed on slippery surfaces.

The tray 40 and the holding means 10 respectively are preferably produced by injection molding. This production method allows a high flexibility when the magnetic elements 20 have to be integrated in the tray 1 or when special designs of the holding means are produced.

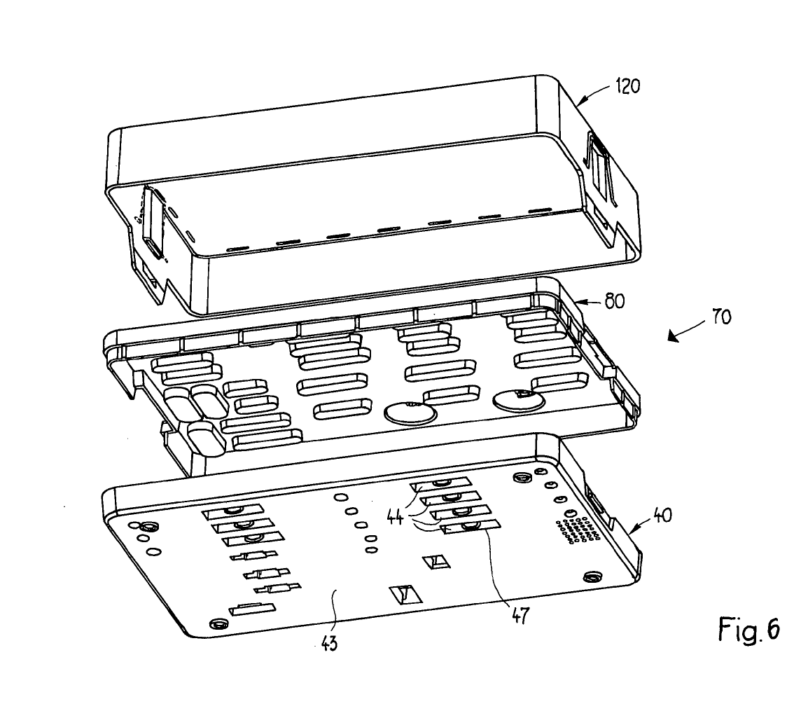

FIG. 6 shows the underside of cassette 70. Base 43 of tray 40 comprises a number of recesses 44. The placement of these corresponds to the protrusions 15 on the upper surface. Magnets are positioned within these recesses 44 and sealed within these by means of covers 47 which are welded onto tray 40.

The use of a magnetic force to retain medical instruments on a tray allows a very easy removal of the medical instruments from the tray. The pull-off force has always the same value whereas with form-fit connections this force does not have always the same value. A pull-off force which has always the same value is of advantage when handling the medical instruments. Further the medical instruments are held exclusively by a magnetic force. There is no additional fitting or holding tool provided in the present invention.

The above described embodiments are for illustrative purposes only and the skilled man will realize that many alternative arrangements are possible which fall within the scope of the claims.

1. A cassette for storing at least one medical instrument comprising at least one tray, the tray comprising at least one holding means for retaining said medical instrument, wherein said holding means comprises at least one magnetic element.

2. Cassette as claimed in claim 1 wherein the holding means further comprises at least one relief structure which defines at least one seat for at least one medical instrument, on which the instrument can be securely retained by magnetic force.

3. Cassette as claimed in claim 2, wherein each relief structure defines a seat for no more than one medical instrument.

4. Cassette as claimed in claim 2 wherein the at least one relief structure is arranged such that, in use, it does not directly contact the medical instrument along its entire length and/or width.

5. Cassette as claimed in claim 2, wherein the relief structure comprises a raised surface, said raised surface forming at least one seat above the surface of the tray on which an instrument can be held.

6. Cassette as claimed in claim 5 wherein the relief structure comprises at least one protrusion.

7. Cassette as claimed in claim 6 wherein the at least one magnetic element is housed within the protrusion.

8. Cassette as claimed in claim 6 wherein the distal surface of the protrusion is shaped to form the seat.

9. Cassette as claimed in claim 2 wherein the relief structure comprises a textured surface such that, in use, channels are formed between the medical instrument and seat for the flow of fluid.

10. Cassette as claimed in claim 9, wherein the textured surface takes the form of at least one longitudinal groove extending along the length of the seat.

11. Cassette as claimed claim 2 wherein the relief structure comprises at least one lateral retention element which at least partially borders the seat.

12. Cassette as claimed in claim 11 wherein the at least one lateral retention element comprises one or more flanges.

13. Cassette as claimed in claim 1 wherein the vertical retention of the at least one medical instrument within the holding means is provided exclusively by magnetic force.

14. Cassette as claimed claim 1, wherein the at least one magnetic element is arranged to provide, in use, a retentive force to the medical instrument of between 1-10N.

15. Cassette according to claim 1, wherein the magnetic element is hermetically sealed.

16. Cassette as claimed in claim 15 wherein the at least one magnetic element is sealed within a recess on the base of the tray.

17. Cassette as claimed in any preceding claim 1, further comprising at least one medical instrument retained within said holding means.

18. Cassette as claimed in claim 17, wherein the seat is defined such that in at least one dimension it is substantially equal to the instrument dimension.

19. Cassette as claimed in claim 18, wherein at least one lateral retention element at least partially borders said dimension such that the lateral retention element closely borders the seated medical instrument.

20. Kit comprising a plurality of medical instruments and a cassette for storing said instruments, the cassette comprising at least one tray, said tray comprising a plurality of holding means for retaining said medical instruments, each holding means comprising at least one magnetic element and relief structure, said relief structure defining a seat for the instrument on which the instrument can be retained by magnetic force.
